(19) United States
(12) Patent Application Publication
(10) Pub. No.: US 2016/0165387 A1
(43) Pub. Date: Jun. 9, 2016

(54) SMART HOME PLATFORM WITH DATA ANALYTICS FOR MONITORING AND RELATED METHODS

(71) Applicant: Hoang Nhu, Irvine, CA (US)

(72) Inventor: Hoang Nhu, Irvine, CA (US)

(21) Appl. No.: 15/045,098

(22) Filed: Feb. 16, 2016

Related U.S. Application Data
(63) Continuation-in-part of application No. 14/836,955, filed on Aug. 26, 2015.
(60) Provisional application No. 62/042,153, filed on Aug. 26, 2014.

(51) Int. Cl. H04W 4/00; H04L 29/08

(52) U.S. Cl. CPC H04W 4/008; H04L 67/10; H04W 84/18

(57) ABSTRACT

A smart home system with data analytics for home monitoring or for monitoring enclosed spaces other than the home. The system can include a BLE mesh network with an embedded gateway and a plurality of repeater nodes running BLE mesh software for use with a Cloud server for receiving data from the gateway through Wifi communication. A plurality of devices each with a sensor and a BLE module can be included with the system and wherein one of the sensors can be a fall detection sensor, a heart and respiratory sensor, or a sensor to detect when a switch or an opening of a door or cap occurs. Other sensors can be included.

### FIELD OF ART

The disclosure is directed to a BLE (Bluetooth Low Energy) Mesh/Beacon-based hardware/firmware system such as an embedded system platform with dedicated gateways running BLE Mesh networking firmware, and with cloud services that can monitor activities, locations, and health and wellness at home or in assisted-living facilities of users and elderlies.

### BACKGROUND

The use of technology to monitor and control different aspects of human activities is ever increasing. There are tools to help with health issues, to track lost items, to communicate, to help exercise, etc. To date, most of these technological solutions are standalone solutions that require the individual to separate configure and manage these devices. Users are better served if multiple of these aid devices can be consolidated and do so in a way that is sleek and user-friendly.

### SUMMARY

The disclosure is directed to a BLE (Bluetooth Low Energy) Mesh/Beacon-based hardware/firmware system such as an embedded system platform with dedicated gateways with cloud services that can monitor activities, locations, and health and wellness at home or in assisted-living facilities of users and elderlies. The BLE Mesh/Beacon-based hardware/firmware system or mesh network for short can extend the BLE range of BLE based devices to cover a much larger area of a home or facility than a typical range without the mesh network to thereby open up many monitoring possibilities in the home or facility.

Applications using BLE based devices that can take advantage of the larger range can include medication schedule monitoring and reminder as described in Ser. No. 62/041,816 filed Aug. 26, 2014, in Ser. No. 14/836,952, filed Aug. 26, 2015, and filed under application entitled SENSORS AND SYSTEMS FOR IOT AND IFTTT APPLICATIONS AND RELATED METHODS, filed Feb. 16, 2016, under Attorney Docket No. 1373-007.401, the contents of each of which are expressly incorporated herein by reference. Another application is for wearable BLE based devices used for slip and fall detection, together with location detection, to alert caregivers when certain patients, such as Alzheimer patients, wander off outside a home or facility. A low-cost automatic fall detection wearable device that works with BLE Mesh to cover a whole house range (including waterproof feature for use in the shower) can be incorporated with the present system. The fall detection device can include a button and a buzzer for 2-way signaling communication with the caregiver. This feature can minimize a false alarm of a fall event and offers additional call/text with GPS and specific location in the house (i.e. near which Mesh-repeaters, or in which room,) in case of emergency. The beacon in the fall detection device, and in any BLE-tagged devices in the areas covered by the mesh repeaters of the present disclosure, makes it possible to detect when an Alzheimer's patient wanders away from his home, and to help a forgetful person locate his lost belongings, such as a key chain.

Still yet another application that can take advantage of the larger range provided by a mesh network is BLE based devices with wireless non-invasive, non-intrusive vital sign monitoring during sleep. The monitoring can look at heart rate (HR) and respiration rate (RR), among others, to ascertain sleep quality. Using micro-electro-mechanical-systems (MEMS), such as accelerometer technology, various vital signs can be monitor to check on heart rate/respiration rate via BCG or ballistocardiography, among others.

The present systems can also be use with BLE based devices to help people that are often forgetful locate their belongings, such as keys, eye glasses, remote controls, etc., via Beacon signal. The various data generated of events and activities by the present system can be timestamped and stored in the Cloud and can serve to alert caregivers regarding emergencies and conditions in real time. Further, by using data analytics, long term trends of a person's health and wellness can be monitored and detected.

Additional features that can assist the elderlies and disabled individuals to live at home are voice-based appliance controllers, such as Smart power plugs controlled via Apple Homekit Ski or Amazon Alexa Voice Services, and live video monitoring using with an IP camera. The Smart power plugs (or SPP) can also serve as Bluetooth Mesh repeater nodes around the house, as further discussed below.

BLE wireless signal, being low energy, has a range limitation that is typically within 25 m. This present disclosure supports a modified BLE MESH software networking scheme that allows a low-cost embedded system platform to monitor, track and control BLE-based devices. For example, the mesh network can be incorporated to extend the range of where BLE based devices can be located within a home or facility, monitored and controlled. Thus, multiple BLE Beacon-based sensors, such as health based BLE devices, smart plugs and thermostats for home appliances can be controlled via the mesh network of the present disclosure.

The present system, via the mesh network, can also be configured to track and locate other commercially available BLE-tagged devices throughout the whole house or facility. This allows the BLE tagged device to be located when it is no longer paired to a smartphone. In contrast, some other BLE Mesh techniques make use of a smartphone as the controller in the MESH network, which is a more expensive solution, both in terms of cost and power consumption, then using a gateway-based mesh network of the present disclosure.

Microphone and speaker in the wifi gateway unit can be include to interact with voice recognition services and/or devices. For example, the present platform can interact with Siri or Amazon Alexa-based voice services to enable useful home automation capability for the elderly and disabled ranging from asking whether the smart bottle dispenser was taken, whether the medication has expired, instructing the system to turn on/off the lights, or checking on last night's sleep quality/respiration rate.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 is a schematic system showing an application of a smart home platform with data analytics for home monitoring and related methods in accordance with aspects of the present disclosure.

FIG. 2 is a schematic BLE mesh network with an embedded gateway for increasing the coverage area for BLE signaling.

FIG. 3A is a fall detection device with a BLE module in accordance with aspects of the present disclosure.

FIG. 3B is a schematic system showing an application of the fall detection device in accordance with aspects of the present disclosure.

FIG. 4 is a schematic drawing of a smart dispenser bottle in accordance with aspects of the present disclosure.

### DETAILED DESCRIPTION

The detailed description set forth below in connection with the appended drawings is intended as a description of the presently preferred embodiments of a smart home platform with data analytics for home monitoring and related components provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

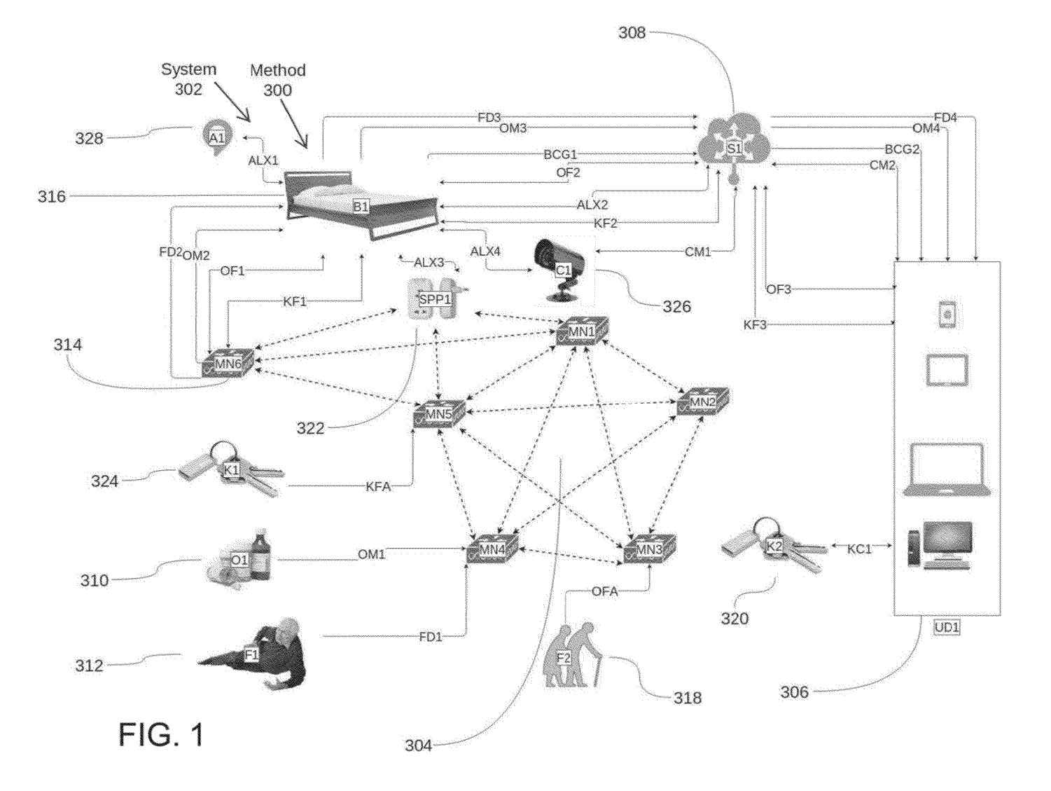

With reference initially to the system 302 for a smart home platform with data analytics for home monitoring and related methods 300 for implementing the system of FIG. 1, a Cloud server 308 with data analytics and a web-browser dashboard is provided to analyze uploaded data for usable information, such as to spot trends, patterns, and “cause-effect” relationships of the various detected activities. Reports can be generated of the information uploaded and collected. For example, the effect on an elderly person's wellness and sleep quality can be tracked and analyzed. If the elderly person takes his medication or forgets to take his medication, the system can recognize the medication event and can even compare the sleep quality of the elderly person when he remembers or forgets to take certain medicine, which can be obtained by a cloud server database. An example of how the system can track a medication consumption event is disclosed in an application entitled SENSORS AND SYSTEMS FOR IOT AND IFTTT APPLICATIONS AND RELATED METHODS, filed Feb. 16, 2016, under Attorney Docket No. 1373-007.401, the contents of which were previously incorporated by reference. The tracking of smart dispenser bottles for medication consumption disclosed in the mentioned co-pending application by the same inventor of the present disclosure can be used with the present system and from-time-to-time may be referred to as a Smart OpenMe pill bottle.

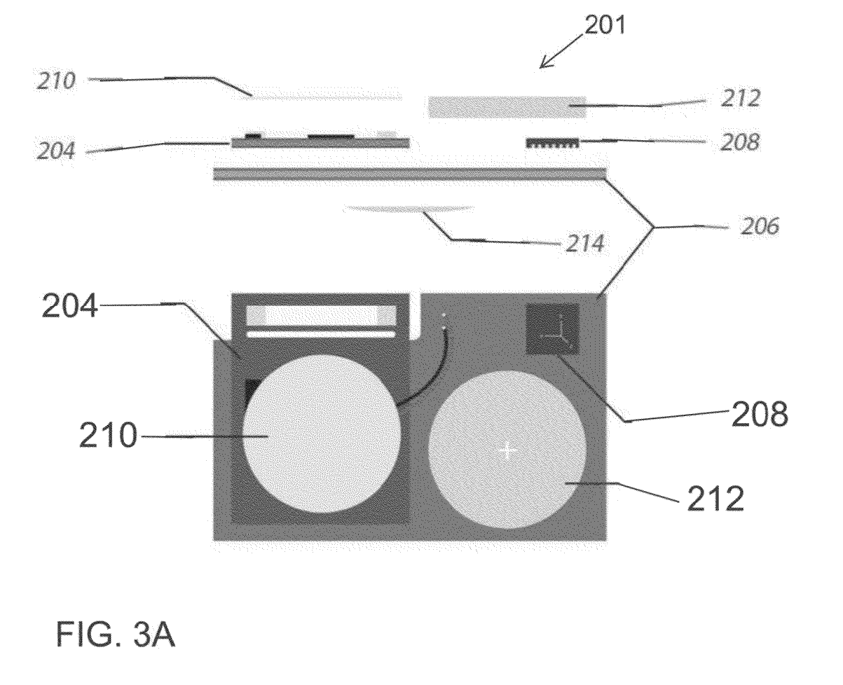

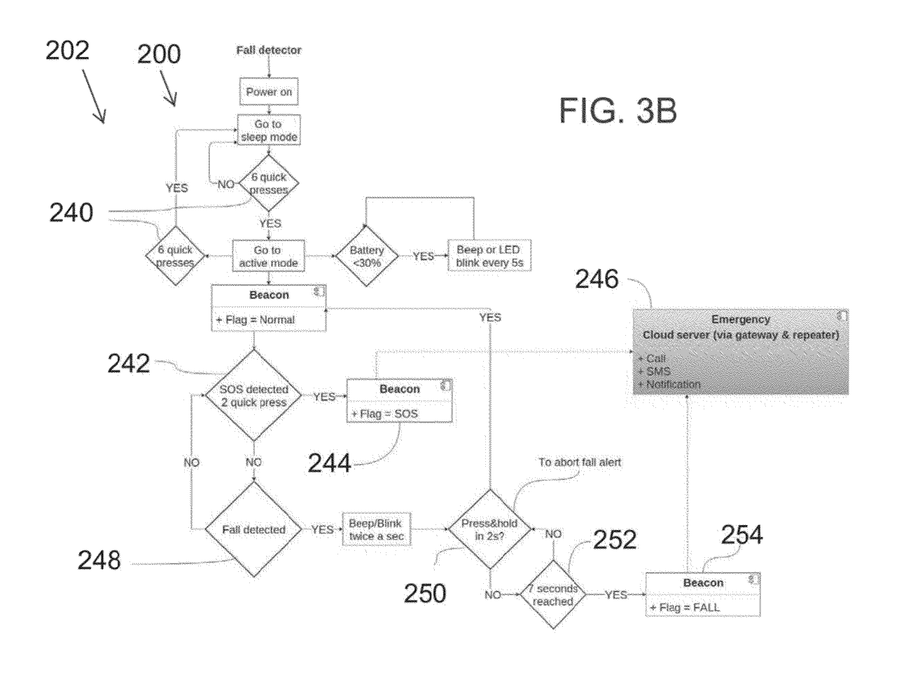

The data analytics can be displayed via graphical charts and optionally as tables and viewable on a PC, Laptop, mobile devices 306 (FIG. 1), or combinations thereof. These various devices for viewing data analytics can generally be referred to as a smart device 306. For emergency situations, such as a fall event detected by fall detection sensor on a fall detection module or assembly 201 (FIG. 3A) or when an SOS or help alarm button is pressed on the fall detection device 201, the Cloud server 308 can send push notification(s) to the caregiver's smart device 306, such as a text to a smartphone, to let the caregiver decide on how best to follow-up.

Note that while the term “home” or “house” may be used to designate an enclosed space for implementing a system of the present disclosure, the system is applicable to other enclosed spaces that are not homes, per se. For example, an office environment, a restaurant, a dormitory, or a garage are enclosed spaces that the system of the present disclosure can operate equally in.

A gateway B1 (FIG. 1) comprising a housing having a PCB with a Wifi module and a BLE module can be positioned or mounted to a bed at 316, for example to the bed frame. The Wifi gateway B1 can be connected to the home Wifi router and the BLE hardware module on the gateway B1 can run a mesh-networking firmware to communicate with surrounding BLE devices and nodes, as further discussed below.

BLE wireless signals, being low energy, have a range limitation that is typically in the order of about a 25 m range, called a typical BLE range. This BLE range limitation can be enhanced or improved, such as to expand the range thereof, by using the low-cost embedded gateway B1 at block 316 and running BLE mesh networking software in or on the gateway board together with a network of BLE Mesh repeater nodes MN1 through MN6 at blocks 304 and 314 of FIG. 1. This solution of using a BLE mesh network enables the system or platform 302 of the present disclosure to utilize multiple BLE beacon-based sensors for health-monitoring and tracking, as further discussed below. The BLE mesh network also allows the system to control home appliances connected to smart power plugs (SPP) wherever they are located throughout the whole house or facility. Further aspects of FIG. 1 are described below. Monitoring and tracking for other than health reasons are also contemplated. For example, tracking electricity usage and a lost key can be part of the present system.

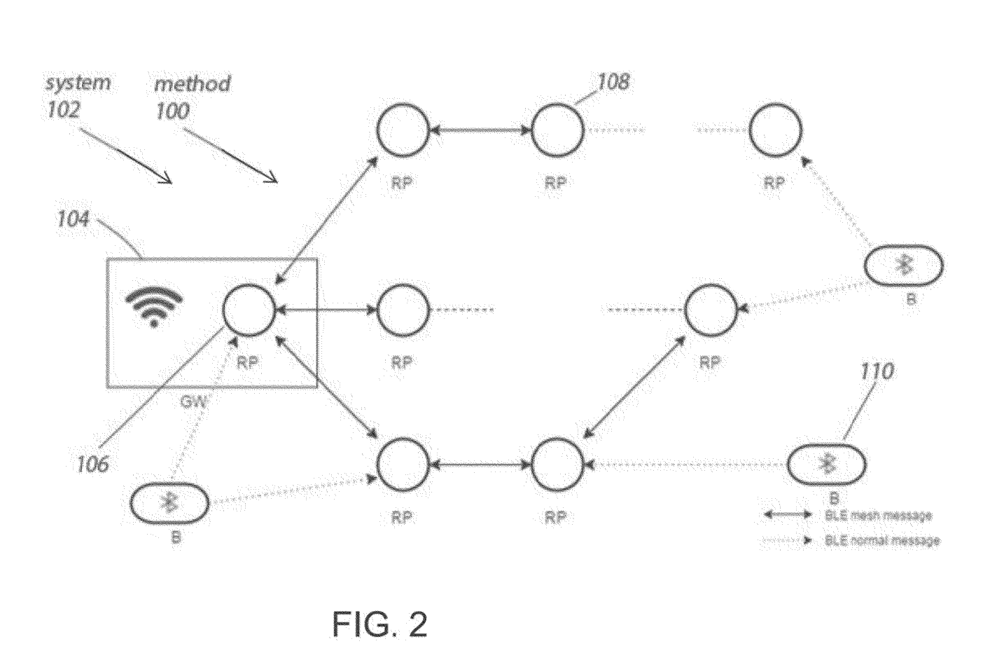

FIG. 2 shows a BLE-Mesh network system 102 and a method 100 for implementing the mesh network in accordance with aspects of the present disclosure. In an example, the mesh network system comprises a Wifi/BLE-Mesh gateway (GW) 104, and a number of BLE Mesh repeaters 108 employed for tracking and monitoring one or more BLE sensors B 110. For discussion purposes, a B sensor can be a BLE Beacon-advertising device such as a Smart OpenMe pill bottle or smart dispenser, previously incorporated herein by reference, a fall detection sensor or a general BLE tagging device described in later sections. These B sensors are end nodes in the BLE network and therefore they do not need to run the Mesh network software protocol. Thus, for a B sensor to send a signal to the gateway or be detected by a gateway from a distance that is greater than a typical BLE range, this requires one or more repeater nodes to relay the message from a B sensor not meant for it or them, if across several repeater nodes, to the next repeater in the network to eventually relay the message to the gateway B1. As the B sensors communicate over regular (non-Mesh) BLE messaging, these BLE sensors consume minimal power and therefore can be battery operated.

The BLE mesh networking protocol enables signals and/or commands to transfer from a sending node to a target node, either directly or indirectly by hopping through other nodes, achieving a much larger range than the typical BLE range of 20-30 m. Mesh networking implemented via flooding approach is a popular method and will not be discussed here. Also BLE Mesh networking using a smartphone as the controller node has been available recently and will not be described here either. The present disclosure is directed to a BLE Mesh network with an embedded or dedicated gateway B1 acting as both as the controlling BLE Mesh node and the bridging component between the Cloud 308 and the Mesh network comprising a plurality of repeater nodes (304, 314 in FIG. 1 and 108 in FIG. 2).

The embedded gateway B1 can eliminate the need for a dedicated smartphone to act as a permanent controller node in the Mesh network. The smartphone would only be needed once during the initial configuration of the Mesh network via the node ID association step. Thereafter the smartphone can be used to receive push notifications when certain preprogrammed events happen, or to control BLE devices on the mesh, over the Internet or a wide-area-network.

The present system allows a BLE beacon signal from a B sensor 110 to be detected by a BLE Mesh repeater 108 (FIG. 2) or by a BLE node 106 in the gateway 104. If the information is first received by a BLE Mesh repeater node 108, it can then relay the information to one or more other repeater nodes 108, depending on the distance, then eventually to the gateway's BLE node 106, which then forwards the information to the Cloud server 308 via Wifi. If the information is received by the gateway's BLE node 106 directly, the gateway then forwards the information to the Cloud server via Wifi without going through a repeater node. Note that the gateway B1 has both Wifi and BLE modules and can act as a bridge between the BLE devices on the repeater's Mesh network side and the Cloud side through Wifi.

The mesh network system 102 (FIG. 2) of the present disclosure can be built by associating all RP repeater nodes 108 relative to one another together with the gateway's BLE Mesh module 106. In an example, a smartphone (with BLE 4.0 enabled) device with an app can be used to associate, such as by assigning IDs 8001, 8002, 8003, etc., to all RP nodes 108 and the gateway's BLE node 106 into a mesh network by manually entering a specific device ID for each of these nodes, and a common Mesh Network ID for all of them. In this way, all these nodes now have distinct ID's and they form a network identified by a specific Mesh network ID. During the association step of each RP node, the RP node must be given a node ID of the gateway's BLE module node 106. In this way, when a B sensor 110 message is relayed from one RP to the gateway, the RP node can directly specify the gateway's BLE node ID as a destination target node. This method is superior than the popular broadcast method which broadcasts the B sensor's message to all nodes in the network that can then cause traffic congestion and delay.

Although the gateways 104 can be configured to direct BLE signals in only one direction, such as to relay collected data to the Cloud server 308 via one-way traffic, the gateways and repeaters can be programmed to receive instructions across the Internet and act on that information. For example, messages from a remote user targeted for a particular BLE Mesh repeater 108, singled out for its specific identifier in the BLE-Mesh network 102, can be transferred to the gateway 104 (FIG. 2) and then that gateway to the particular repeater 108. Using Mesh protocol, the particular repeater's ID can be resolved. For example, these bidirectional messages can carry commands to emit an alert or an alarm at a particular repeater node, or to turn on/off lights at a particular Smart power plug SPP1 in 322 of FIG. 1.

Via additional BLE association step described above, additional repeaters 108 can be added to the MESH network, in the same Mesh network ID, to extend the range of the network. Similarly, these repeaters can be removed from the Mesh network. More B sensors 110, such as additional Smart pill bottles or other Beacon tagging devices, can also be added. But these additions can be performed differently: as they are non-Mesh devices, they can be added not via association of Mesh nodes, but rather via customized firmware in the repeaters 108 to allow scanning for these specific new BLE broadcasting devices (BBDs).

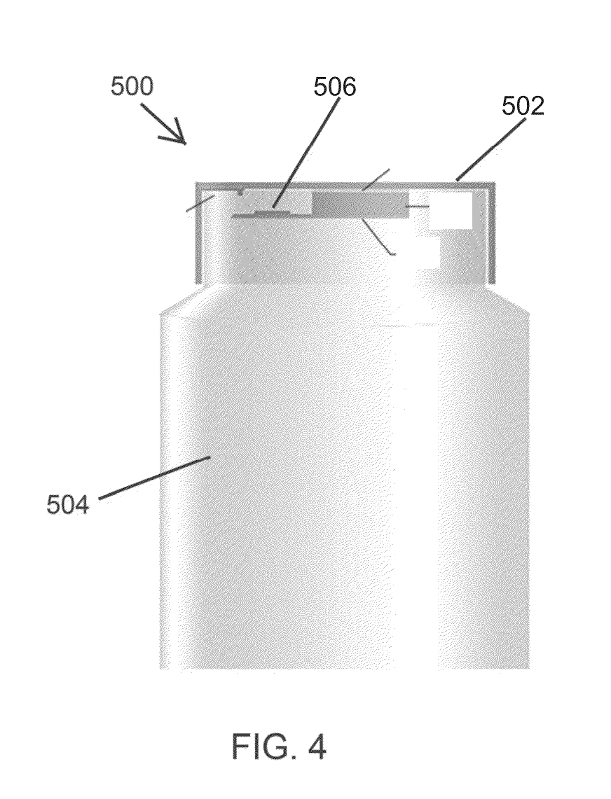

FIG. 4 shows a smart storage device or bottle 500 as described in co-pending application an application entitled SENSORS AND SYSTEMS FOR IOT AND IFTTT APPLICATIONS AND RELATED METHODS, previously incorporated by reference. When multiple such smart storage bottles 500 are opened by moving the cap 502 relative to the base 504, the BLE sensors 506 located with each of the smart bottles, such as located under the caps, are powered on or energized to broadcast their respective opened state to the nearest repeater and then the state is then relayed across the Mesh network, which then relays that information to the cloud 308 via the gateway 104, 316, such as through Wifi from the gateway to the Cloud server. When a smart bottle 500 is in a closed state and the onboard electronics 506 is opened, the onboard BLE module 506 does not transmit its Beacon signal and does not consume any power.

Each open event for each of the smart pill bottles 500 can be logged in the cloud server 308 to keep track of an individual's medication usage and to remind him in case he forgets to open the bottle according to a prescription schedule entered into a calendar on the cloud server, as described in the co-pending application. In addition, memory in the BLE sensor 506 can include an index ID to the medicine prescription stored in the cloud server's database. Upon opening the cap 502, via this index ID, the medicine information can be retrieved from the database and can be read out loud via text-to-speech service running on a smartphone or on the gateway.

With reference now to FIG. 3A, a side exploded and top view of a fall detection (FD) assembly 201 in accordance with aspects of the present disclosure is shown. In an example, the fall detection assembly 201 comprises a printed-circuit board PCB 206 having a BLE module 204, an accelerometer sensor chip 208, such as 3-axes accelerometer chip, a buzzer 210, a coin cell battery 212, which can also be a rechargeable Li-Ion battery, and a button/switch 214. The FD assembly 201 can be enclosed in a case (not shown) or housing that can include means clipping the case onto the shirt or other clothing article of a user, placed inside a pocket, worn as a necklace, or worn around the upper arm.

When the user is in the standup vertical position, depending on the orientation of the accelerometer chip 208 with respect to this vertical position, one of the 3 axes, say a Y-axis, can have a maximum (absolute) value reading. Under a fall condition, the user can lie down in a (near) horizontal position in one of 4 possible positions, including face down, face up, sideway left, or sideway right. In these 4 positions, the Y-axis can give a reading of zero or near zero. By monitoring this Y-axis value over a programmable time interval to determine more accurately that the fall event is a real event, the FD assembly 201 can automatically detect and send an alarm in case of a slip and fall accident that can be detected by the gateway and then forwarded to the Cloud server for additional programmable functions, commands, or options. Also, by monitoring the other two axes, such as the X and Z axes, dynamically during the fall, the fall detection assembly 201 can determine and process the fall condition even more accurately.

In a 13-bit accelerometer sensor, in the vertical position, the Y-axis value is near the max value of −4096 or +4095. In the horizontal position when the person falls face up or down, or sideway left or right, this Y value is near a zero 0 value. Different fall events can be tested and analyzed and the fall threshold can be empirically discover and programmed. In an example, the Y-axis value can fall within the range from −10% to +10% of the max value possible for a particular N-bit accelerometer chip. For the 13-bit accelerometer example, this range is between about −409 to +409 counts. When the Y value stays within this range for at least 4 seconds, a valid fall event can be assumed or flagged, otherwise any variation in values can be treated as a non-fall event. This range and the 4-second duration can be programmed to different values for different detection sensitivity and system responsiveness.

Via a firmware algorithm running on a microcontroller in a BLE module 204 (FIG. 3A) that reads input data from accelerometer 208 and/or a button/switch 214, this fall detection apparatus 201 can activate the Beacon signal with different flags indicating different scenarios for a nearby BLE Mesh repeater to forward these events along with the repeater ID. The repeater ID can be linked to a location, such as Bedroom #1, and when this repeater ID is received by the Cloud via the gateway, the exact or precise location of the fall can be detected or determined.

FIG. 3B shows a fall detection system 202 and a method 200 for implementing the system in accordance with aspects of the present disclosure. With reference to FIGS. 3A and 3B, by pressing on a button or a switch 214 on the FD assembly 201, the user, according to certain preprogrammed patterns or functionalities, can send a push notification (or dial a number via a call center) in case of an SOS emergency or for other reasons other than a fall event.

In case of a slip and fall as detected by the 3-axis accelerometer 208 and processed by a programmable firmware algorithm, described further below, the push notification or the call-center dialing can be activated automatically, which can be useful just before the user loses consciousness or when the user loses consciousness and the button is pushed by another.

In case of fall but the user wearing or having the FD assembly 201 is not hurt, he can press the button/switch 214 before a programmable timeout period expires to cancel the push notification. As BLE messaging over Mesh network 102 can be bidirectional, the cloud server can acknowledge the SOS emergency or fall event by returning a message to the repeater node, which had detected and reported the fall event in the first place. This repeater can then decode the message and plays an audible message or tone to let the user know that help is on the way.

With further reference to the method 200 of FIG. 3B and the device 201 of FIG. 3A, the flowchart of the fall detection firmware algorithm in the FD system 202 will be discussed. In this figure, dotted lines indicate wireless BLE beacon message between the FD assembly 201 and BLE repeater nodes 108 in the Mesh network 102. Solid lines indicate program flow in the microcontroller of the FD assembly's BLE module 204 of FIG. 3A. The first step for performing the disclosed method 200 is to power on the FD assembly.

At step 240, the FD device 201 is activated or deactivated via pressing the button/switch 214 (FIG. 3A) on the device. Pursuant to certain programmable pattern, 6 quick presses can be employed to wake up the FD sensor 204 to advertise its Beacon with flag cleared to normal to detect any fall event, subsequent to the activation step 240. Another 6-quick presses of the button 214, or pursuant to some other programmable pattern, can toggle the FD device 201 to go into sleep mode to conserve battery power when not in use.

At step 242, the device 201 checks to determine if the user has launched an SOS alert request via two quick presses of button 214, or pursuant to other programmable pattern. If this event happens, then the program flows to step 244 to set the beacon's flag to SOS. This flag code is then received by the BLE repeater 108 and eventually forwarded to the cloud server via the gateway 104 (FIG. 2). At step 246, the cloud server decodes the flag and sends an SOS alert via push notification, SMS or by phone dialing.

At step 248, the microcontroller in the FD device's BLE module 204 determines the fall event by continuously reading the Y-axis values over a period of 4 seconds and checking if the values are all in the range between −409 to +409 counts. When these conditions are met, fall is detected and the module beeps or blinks twice a second for feedback to the user. Within 7 seconds from the time when fall event is first detected, the user can be provided with a chance to abort the pending alert by pressing and holding the button 214 on the device 201 for 2 seconds. This abort request is checked in step 250 to decide whether to abort or to continue with the 7-second countdown in step 252. When the 7-second timeout is reached, at step 254, the Flag of the Beacon message is set to FALL. This Flag code can be received by the BLE repeaters 108 (FIG. 2) and forwarded to the cloud server via the gateway 104. At step 246, the cloud server decodes the Flag and sends a FALL alert via push notification, SMS, or phone dialing.

Location tracking and asset management are two other useful ‘Non-Fall” related features that can be supported by the same FD device 201 of the present disclosure. Typically, in order to minimize battery power consumption, the Beacon signal from the FD device's BLE module 204 is only turned on with the correct Flag value when a Fall-event or an SOS emergency button press sequence is detected. Normally, the Beacon signal should be turned off to extend the battery life of the FD device 201. However, to support certain features of the present disclosure, the FD device's Beacon module 204 (FIG. 3A) can be left active, such as left on or energized, to signal to nearby repeaters 108 (FIG. 2) its identification and presence. When using the FD device 201 as a location tracking device, the BLE module should be on so that the Beacon from FD device 201 can be scanned by the repeaters 108 and the gateway 104 to track and detect in which room the elderly person is located or whether he has left the house or facility.

Another application of the present system is for asset management. If the elderly person does not wear the FD device 201, its location can still be detected by the repeaters and reported on cloud server's dashboard. Using this same approach and infrastructure, other BLE key-finder devices or third party devices such as Tile and TrackR tagging devices can be tracked, via their Beacon. As an example, when a BLE-based key finder K2 at 320 (FIG. 1) is in the connected mode with the user's smartphone UD1 via BLE wireless standard, the BLE-based key finder K2 does not transmit its Beacon. When this connection is broken due to the BLE-based key finder K2 being misplaced and out of BLE range from the smartphone, the key finder K2 starts its Beacon and includes its ID in the emitted message. This broken connection is represented by the BLE-based key finder K1 at 324, which is not paired or connected to any smartphone. Thus, looking at BLE-based key finder K1 at 324 as representative of a condition in which there is no pairing, the BLE device K1 will emit is beacon for detection or scanning by other BLE based scanning devices. A nearby Mesh repeater node MN5, which can be similar to one of the repeater nodes 108 of FIG. 2 in the mesh network previously discussed, can receive this message and can report the presence of K1 to the user via the cloud services 308.

In order to conserve battery power in the above two-noted applications, the Beacon is configured to be active full time but with a much slower Beacon advertising interval of 5 seconds instead of the 1 second interval when a fall event occurs. This can be implemented to conserve some energy.

The detection system and method for detecting an OpenMe Smart pill bottle and cap, the FD device, and devices for location-tracking and asset management are described next. Referring again to FIG. 1, the detection of an open event of a smart dispenser bottle 01 at 310 can follow the following steps: when opened, via path OM 1 and OM2, the smart bottle 01 BLE module's Beacon message is relayed to gateway B1 at 316. Via wifi path OM3, this message is sent to the cloud server S1 308 for retrieving all the information about the medicine prescription and for logging this medicine taken event in the database on the Cloud server. Conversely, if the medicine is not taken on time according to a prescription schedule stored in the database calendar, which is detected by the missing Bottle Opened event, then notification can be sent to caregiver's phone as a reminder. The cloud server software updates the count of remaining pills in the bottle based on these bottle open events to estimate when the next medicine refill date should be scheduled or planned.

Via path OM4, the cloud server updates a web-browser dashboard for the user to view all the updated information via his PC or mobile device 306. Alternatively, via text-to-speech service, the cloud server can convert the text from the prescription in the database into an audio file for streaming to the gateway B1, with a speaker in B1 playing back this audio file. The system can read out loud the medicine information. This helps confirm to the user that the medicine bottle he opens each time is indeed his prescription. Additional information, such as its expiration date and dosage, etc., can also be provided. This entire process flow and features of the smart dispenser device can also be supported via a BLE-enabled smartphone and an app instead of the gateway B1 316 and its embedded firmware.

Similar to the gateway, the BLE-enabled smartphone would bridge the cloud server 308 via its wifi or 3G wireless on one end and the BLE Mesh network on the other end. Using an OpenMe Smartphone app, the user can talk to the phone's microphone to ask question and receive voice response about the Smart dispenser device that was previous registered in the cloud server's database. The following questions can be addressed by the present system: Did I take my medicine today? What is the expiration date of my medicine? How many pills are remaining in my pill bottle?

Steps to process these voice inquiries can start with a voice recognition service such as the new Amazon Alexa Voice services AVS which interfaces with the cloud server 308 to retrieve the information needed about the medicine in smart dispenser bottle. The retrieved information in text format is passed back to the Amazon AVS server for text-to-speech conversion and for download and playback on the user's smartphone.

Referring again to FIG. 1, the detection of a fall detection event in the sensor F1 312 can follow the following steps: when fall event occurs, via path FD1 and FD2, the FD device's Beacon message is relayed to the gateway B1 316. Then via path FD3, this message is sent to the cloud server S1 308 for sending alert, such as push notification to a caregiver's phone. The repeater node nearest the FD device stores the FD device ID and this information can be inquired by the caregiver remotely via the dashboard via path FD4. This allows the caregiver to locate approximately where the fall event occurs based on the location of its nearest repeater node.

Location tracking F2 318 and asset management K1 324 can be implemented using a similar mechanism. The Beacons from the FD device worn by the elderly person and from a tagging device on key rings can be detected and stored in the nearest repeaters. Via paths OF1, OF2, OF3, and KF1, KF2, KF3, the location of the elderly person and the key ring, respectively, can be inquired and reported by the user at dashboard 306.

A BallistoCardiography (BCG) sensor is a MEMS-based accelerometer that can be placed on bed frame to measure small BCG signals in the recoil effect caused by the blood flowing into a person's aorta and further into the arteries. This motion is mainly along the longitudinal axis of the body. Software in the BCG MEMS-based accelerometer module analyzes these signals and extracts important vital signs, such as heart rate HR and respiration rate RR. Aspects of the present disclosure use these parameters to measure sleep quality.

In some embodiments, a BCG sensor is integrated on the same PCB board as gateway B1 316 to measure heart rate HR and respiration rate RR. The gateway B1 then streams the HR/RR data over Wifi to the cloud server S1 at 308 for live display on a dashboard of a user's device 306. These steps are indicated in paths BCG1 and BCG2 in FIG. 1. Thus, the individual's caregiver, doctor, or family members can log into the Cloud server, after proper authentication, to view the individual's sleep quality and important vital signs.

Another use for the BCG accelerometer sensor is to detect when a user is in bed, via his heart rate or his motion. This information, together with the wearable FD sensor module 201 in FIG. 3A, helps to reduce false alarm rate of fall detection compared to when the FD sensor is working alone.

The challenge with the FD sensor's fall detection algorithm (in flowchart FIG. 3B) is that it can send a false fall-event alarm when the person intentionally lies down, unless he switches off the device. Combining with BCG data, the cloud server 308 of the present system can determine when the user is resting in bed where the BCG is located, and the server can use this information to decide whether it is a true fall or not. After the user's wearable FD sensor detects and sends a Fall Beacon message, in block 228 of FIG. 3B, the cloud server can look at the BCG data to check if the person is in bed or not, then it can send the push notification to alert accordingly. This helps reduce false alarm cases in fall detection.

In some examples, BLE-Mesh based smart power plug SPP1 at 322 in FIG. 1 can be incorporated with the system 302. Typically, BLE nodes that form the BLE mesh network, such as the network shown in FIG. 2, can be pure repeater nodes that run mesh-“flood” networking firmware to extend the transmission range of BLE beacons. Alternatively, they can be of the SPP1-type that serves both as a repeaters and as wireless ON/OFF AC-outlets for remote control of home appliances. Other features that can be built into these SPP1 plugs can include monitoring capability to monitor the power consumed by the plugged-in home appliance that is plugged into the SPP1. In some examples, sensors can be built into a SPP1 plug, such as passive infrared sensor (PIR) motion detector, ambient light sensor (ALS), relative humidity/temperature (RHT) sensor, etc. When integrated into one SPP1, the power consumption of the appliance plugged into the SPP1 plug and the sensors' values of sensors built into the plug can be sent to the Cloud server and be remotely monitored from the dashboard. These values and information can be sent to the Cloud server via the gateway and the BLE Mesh network, as previously described.

With software voice recognition services such as Apple HomeKit Siri and Amazon Alexa AVS, the present system can include voice recognition and text-to-speech functionalities. In an example, microphone and speaker can be incorporated into the Wifi gateway B1 316. This can enable the platform of the present disclosure to have useful smart voice home automation capability for the elderly and disabled. This feature is supported via paths ALX1, ALX2, in FIG. 1, where ALX1 is the interface to Amazon Alexa AVS cloud 328 and ALX2 is the interface to the cloud server 308 of the present system. Whereas the Amazon AVS cloud 328 supports voice-related functions, such as voice recognition and text-to-speech, the cloud server 308 of the present disclosure either sends control signals to carry out these voice-commands or retrieves information found in its database for the Alexa AVS service to read the information out loud.

When the voice-based feature is incorporated into the gateway B1 316, a user can perform voice-controlled home automation. For example, the user can issue a voice command that is picked up by the gateway's microphone, the captured audio is sent to the Alexa AVS Cloud A1 328 speech recognition to convert voice to text command which is then processed by the Cloud server 308 and its database. The Cloud server 308 then sends messages to the gateway 316 to relay to the particular node to carry out the instructions. For example, the gateway 316 can forward the control command to the smart power plug SPP1 322 to turn on/off lights or TV set, to the smart thermostat to turn the heater turn on/of, or the control switch for the fan to turn on/off. In another example, upon the smart bottle dispenser's open event, BLE messages can be sent to the gateway 316 or a smartphone 306 to read the medicine information out loud, warn if the medicine is approaching its expiration date, or state which patient the medicine is for. This information can be retrieved from the cloud 308 database based on the smart bottle dispenser's beacon containing the ID index of the medicine.

In another example, the user can be away from home but can still instruct the system to issue a command, such as to turn on/off one of the lights, or to ask whether he has taken his pill for the day. Via his smartphone app, the user can issue such a voice command that is sent to the Alexa AVS Cloud A1 328 to convert voice to text which is processed by the Cloud server 308 and its database. The Cloud server 308 then sends instructions to the gateway 316 to relay to the particular node to carry out the instructions. For example, the gateway 316 can forward the control command to the smart power plug SPP1 322 to turn on/off lights. In case the user's voice command expects a voice response such as the above inquiry about whether any pill has been taken that day, cloud server 308 searches its database for this information and returns it to Alexa AVS to convert to voice; Alexa AVS then sends back this voice data to the user's smartphone for playback.

In another example, when a user wakes up in the morning, he can inquire about his sleep cycle or pattern and/or his respiration rate based on the BCG data collected and stored in cloud server 308. The user can speak into a phone app, or the gateway 316 speaker which then sends the voice data to the Alexa AVS Cloud A1 328 to convert voice to text which is processed by the Cloud server 308. The Cloud server 308 then retrieves the requested information from the cloud database, such as stored HR/RR data. The Cloud server 308 then sends the text back to the Alexa AVS Cloud 318 to convert the text to voice. The voice data is then sent to the gateway 316 or to a cell phone 306 to read the requested information.

In an example, the system or platform 302 can optionally include live video monitoring via an IP camera 326, as shown in FIG. 1. Referring to data path CM1 and CM2 of FIG. 1, this video feature can be integrated and viewable from the same web-based dashboard that displays all other sensors data.

Although limited embodiments of a smart home platform with data analytics for home monitoring and related components provided in accordance and their components have been specifically described and illustrated herein, many modifications and variations will be apparent to those skilled in the art. Accordingly, it is to be understood that the systems and assemblies and their components constructed according to principles of the disclosed devices, systems, and methods may be embodied other than as specifically described herein. The disclosure is also defined in the following claims.

What is claimed is:

1. A smart home system with data analytics for home monitoring comprising:
a BLE mesh network comprising an embedded gateway and a plurality of repeater nodes running BLE mesh software; said gateway comprising a Wifi module and a BLE module;
a Cloud server for receiving data from the gateway through Wifi communication;
a plurality of devices each comprising sensor and a BLE module; and
wherein a fall can be detected by one of the sensors and a location of one of the sensors relative to a particular repeater node can be detected and relayed via the gateway to the Cloud server.

2. The system of claim 1, wherein one of the sensors is a BCG sensor for detecting heart rate and respiratory rate.

3. The system of claim 1, wherein one of the sensors is an accelerometer for detecting signals along a Y axis.

4. A system for detecting a fall condition comprising:
a housing comprising a BLE module and an accelerometer;
a BLE mesh network comprising an embedded gateway and a plurality of repeater nodes running BLE mesh software; said gateway comprising a Wifi module and a BLE module;
a Cloud server for receiving data from the gateway through Wifi communication; and
wherein the information received is from an accelerometer detecting a signal along a Y axis.
